(19) United States
(12) Patent Application Publication
(10) Pub. No.: US 2014/0231732 A1
(43) Pub. Date: Aug. 21, 2014

(54) HYDRAULIC JACK FOR VEHICLE

(71) Applicants: MINDRUT PETER PIUIAN, PLYMOUTH, IN (US); DAVID MARC, PLYMOUTH, IN (US)

(72) Inventors: MINDRUT PETER PIUIAN, PLYMOUTH, IN (US); DAVID MARC, PLYMOUTH, IN (US)

(21) Appl. No.: 13/769,974

(22) Filed: Feb. 19, 2013

(51) Int. Cl. B60S 9/12

(52) U.S. Cl. CPC B60S 9/12
USPC 254/423

(57) ABSTRACT

A system for jacking a motor vehicle comprising: a telescoping hydraulic jack positioned near on at least one wheel of the motor vehicle, where said telescoping hydraulic jack includes a base and a plurality of sections connected to the base; and a means to supply hydraulic fluid to each telescoping hydraulic jack. The plurality of sections may include a first section connected to the base, a second section connected to the first section and a third section connected to the second section where the third section attaches to a frame of the motor vehicle. In one particular embodiment, the telescoping hydraulic jack is mounted near each wheel of the motor vehicle.

### BACKGROUND OF THE INVENTION

1. Field of Invention

The present invention relates to a hydraulic jack system that provides a hydraulic power jack on a motor vehicle.

2. Description of Related Art

It is well-known one of the drawbacks of motor vehicle use is the occasional mechanical breakdown that may occur over a period of time. Although most mechanical breakdowns are unforeseen and require the skill of a trained mechanic, a common breakdown relates to a flat or a deflated tire. Tires typically become flat due to wear and tear or the accidental encounter with a nail or a piece of glass. Once punctured the tire must be changed in order to operate the motor vehicle. Since a flat tire can occur anytime during the operation of a vehicle, many individuals must change the tires themselves prior to going to a mechanic to purchase a new tire. Many motor vehicles come equipped with a manual jack system that requires placement of the jack onto the frame or bumper of the vehicle in order to raise the vehicle sufficiently to remove the tire from the axle. This process can be laborious and many individuals may not have the physical stamina or strength to change tire manually. Therefore it would be advantageous to have an apparatus to alleviate the physical labor associated with the changing of a flat tire manually by an individual.

### SUMMARY OF THE INVENTION

The present invention relates to a system for jacking a motor vehicle comprising: a telescoping hydraulic jack positioned near on at least one wheel of the motor vehicle, where said telescoping hydraulic jack includes a base and a plurality of sections connected to the base; and a means to supply hydraulic fluid to each telescoping hydraulic jack. The plurality of sections may include a first section connected to the base, a second section connected to the first section and a third section connected to the second section where the third section attaches to a frame of the motor vehicle. In one particular embodiment, the telescoping hydraulic jack is mounted near each wheel of the motor vehicle.

### BRIEF DESCRIPTION OF DRAWINGS

FIG. 1 depicts placement of hydraulic jacks according to the present invention onto the frame of a vehicle.

FIG. 2 depicts a hydraulic jack in accordance with the present invention.

### DETAILED DESCRIPTION

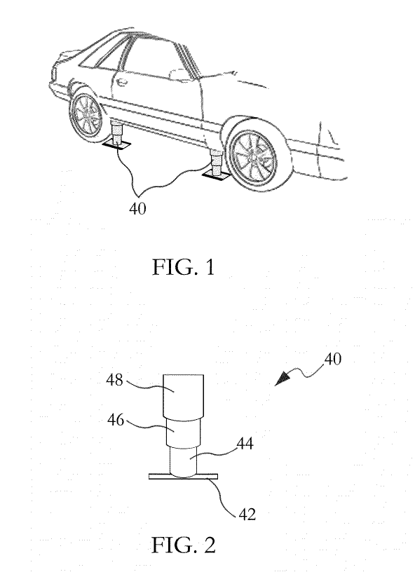

The present invention relates to a hydraulic jack system for use with a motor vehicle. The present invention utilizes a hydraulic jack, which is placed directly onto the frame of a vehicle. The hydraulic jack according to the present invention includes a hydraulic pump and a battery located in the trunk of the car. As depicted in FIG. 1, a particular embodiment of the present invention is depicted. This embodiment depicts two hydraulic jacks 40 attached to the frame of a motor vehicle. As depicted in FIG. 1 a hydraulic jack placed near the axle of each wheel of the vehicle shown in FIG. 1. In this particular embodiment, two hydraulic jacks are provided; one near the front wheel axle and another near the rear wheel axle. The hydraulic jacks are powered through the hydraulic pump as provided in the trunk of the vehicle, not shown. Each hydraulic jack 40 is in a piston-type jack with a flat base to put for the jack during operation. In one exemplary embodiment, the hydraulic jack 40 may include LED lighting where the LED lighting ignites when the hydraulic jack 40 is actuated by the user.

FIG. 2 depicts a perspective view of a hydraulic jack in accordance with the present invention. The hydraulic jack 40 includes three telescoping sections. The first section 44 is adjoined to a base 42 as shown in FIG. 2. The base 42 comes in contact with the ground surface as the hydraulic jack 40 is raised into an expanded position. As the hydraulic jack 40 expands a second section 46 extends from a top section 48. The second section 46 and the first section 44 extend downwardly to place the base 42 in contact with the ground surface under the vehicle and places the hydraulic jack 40 in an extended position. Although not shown, a hydraulic pump within the trunk of the vehicle directs hydraulic fluid to each hydraulic jack 40 to extend the jack into a raised position. In one particular embodiment, a remote control is used to operate the hydraulic jack 40 so that an individual merely needs to activate the hydraulic jacking system with the mere use of a remote control. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for jacking a motor vehicle comprising:
a. a telescoping hydraulic jack positioned near on at least one wheel of the motor vehicle, where said telescoping hydraulic jack includes a base and a plurality of sections connected to the base; and
b. a means to supply hydraulic fluid to each telescoping hydraulic jack.

2. The system for jacking a motor vehicle according to claim 1, where the plurality of sections include a first section connected to the base, a second section connected to the first section and a third section connected to the second section where the third section attaches to a frame of the motor vehicle.

3. The system for jacking a motor vehicle according to claim 1, where a telescoping hydraulic jack is mounted near each wheel of the motor vehicle.
